(19) United States
(12) Patent Application Publication
(10) Pub. No.: US 2012/0144434 A1
(43) Pub. Date: Jun. 7, 2012

(54) Hospitality Set-Top to Television Interface

(75) Inventor: Jonathan T. Smith, Washington Township, OH (US)

(73) Assignee: PDI COMMUNICATIONS SYSTEMS, Springboro, OH (US)

(21) Appl. No.: 13/309,346

(22) Filed: Dec. 1, 2011

Related U.S. Application Data
(60) Provisional application No. 61/418,429, filed on Dec. 1, 2010.

(51) Int. Cl. H04N 21/214

(52) U.S. Cl. 725/78

(57) ABSTRACT

A set top box interface 10 for one or more televisions permits the one or more televisions to directly control one or more associated set top boxes so that the each television may provide an integrated remote control interface for television and set top box functions. Under direction of the interface 10, when each television is viewing the video source controlled by the interface, the television forwards remote control functions received by each television to the interface and translated for control of each associated set top box. The interface, after translation, forwards these remote control functions to the associated set top box. The invention is particularly useful in patient care environments where the television controls may be integrated into a pillow speaker/pillow remote, which can have a simple and intuitive format and yet control all of the relevant functions needed by the patient/guest functions of the set top box and television.

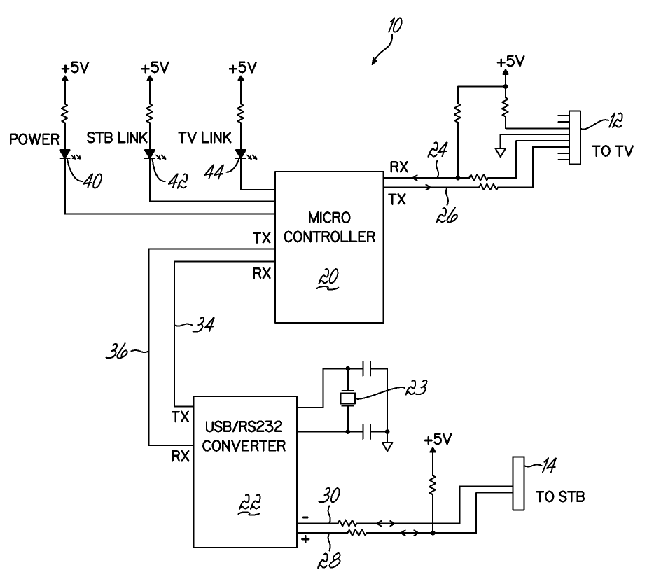

### FIELD OF THE INVENTION

The present invention relates generally to controllers for set top boxes, and to controllers used in hospitality facilities such as pillow speakers.

### BACKGROUND OF THE INVENTION

In hospitality facilities, particularly patient care facilities, televisions are often integrated into the room in unique ways that are different from conventional consumer environments, using remote control and sound distribution systems that differ from conventional consumer environments in private homes.

For example, in a patient care facility, patients are often bedridden or otherwise unable or have limited ability to move, and as a result, remote control systems are necessary and it is necessary that they be simple and intuitive to minimize patient training. Furthermore, patients often share rooms as a cost-saving and safety measure, and as a result, the remote control is often integrated with a speaker that is wired into the patient's bedside, often referred to as a pillow speaker or pillow remote. This arrangement allows the patient to control the television and brings the speaker closer to the patient to reduce the ambient noise in the patient room. Televisions equipped with pillow speakers or pillow remotes, or adaptable to use pillow speakers or pillow remotes, are available through mass market vendors and also a number of specialty vendors.

Over the past several years, the number options in television programming have expanded, from (initially) a small range of broadcast channels, to (currently) a wide range of hundreds of channels available from satellite TV, cable TV, internet-based television and video sources, in addition to the expanded lineup of digital broadcast channels that has replaced the prior analog spectrum. This expansion has greatly improved the entertainment options to consumers; unfortunately, it has created difficulties in bringing these options to patient care facilities or other hospitality industry facilities. A first problem is that reception of satellite or cable TV, and in some cases even digital broadcast TV, requires the use of a set-top box independent of the television set. Legal and practical restrictions typically limit the options to integrate set top boxes with hospitality televisions, or to rebroadcast satellite channels in such a way that existing hospitality televisions can select programming using conventional channel changing. This means that control of the television viewing through a conventional pillow speaker is frequently limited to volume and power controls, as other functions are only controllable through the set-top box remote separate from the pillow speaker. Providing patients or guests with a separate remote is often not a satisfactory solution, as the separate remote is cumbersome, easily lost, and confusing. Furthermore, the typical set top box remote includes controls of a number of set up and configuration functions that are not needed in a hospitality facility and are only a source of confusion and distraction.

### SUMMARY OF THE INVENTION

The present invention is generally directed to a set top box interface for a television that permits the television to directly control the set top box so that the television may provide an integrated remote control interface for television and set top box functions. The invention is particularly useful in patient care environments where the television controls may be integrated into a pillow speaker/pillow remote, which can have a simple and intuitive format and yet control all of the relevant functions needed by the patient/guest functions of the set top box and television.

Furthermore, in many applications for this invention, multiple set top boxes and multiple televisions may be present in a particular proximity to each other, particularly in patient care facilities where rooms are shared. This invention includes an interface configured to connect one or more televisions and the respective associated set top boxes to one set top box interface.

Various refinements exist of the features noted in relation to the above-mentioned aspects of the present invention. Further features may also be incorporated in the above-mentioned aspects of the present invention as well. These refinements and additional features may exist individually or in any combination. For instance, various features discussed below in relation to any of the exemplary embodiments of the present invention may be incorporated into any of the aspects of the present invention alone or in any combination.

### BRIEF DESCRIPTION OF THE DRAWINGS

The accompanying FIGURE, which is incorporated herein and constitutes a part of this specification, illustrates a circuit diagram of a satellite interface circuit in accordance with an exemplary embodiment of the invention and, together with a general description of aspects of the invention given above, and the detailed description of various exemplary embodiments given below, serve to explain various principles of the invention.

### DETAILED DESCRIPTION OF THE INVENTION

A Satellite Television Interface 10 in accordance with the present invention consists of a single circuit board integrated into a set top box connection between one or more television receivers coupled to connector 12 and an associated set top box coupled to connector 14. The board is powered through the STB connection 14, which is a standard USB connection, and thus does not need a power supply.

Referring to the FIGURE, the board comprises a microcontroller 20, such as a Freescale MC9S08AC16CFG (available from Freescale semiconductor, 2100 East Elliot Road, Tempe, Ariz. 85284), a USB-to-RS-232 converter IC 22, such as a Prolific PL2303X (available from Prolific Inc., 7F, No. 48, Sec. 3, Nan-King Rd., Taipei, Taiwan, R.O.C.) running a 12 MHz crystal clock 23, and one or more RJ45 jacks 12 for each coupled TV and one or more USB type B jacks 14. The RJ45 jacks support a serial communications protocol with the televisions, such as the CCI protocol promulgated by PDI, the assignee herein. The serial protocol is supported by receive and transmit lines 24 and 26, respectively, using programming within microcontroller 20. This permits the Interface to communicate with any television supporting the CCI protocol.

Control signals generated by the microcontroller are exchanged with USB-to-RS-232 converter IC 22 via RS-232 compatible communications on lines 34 and 36, respectively. The USB jacks 14 connect internally to converter IC 22 via positive and negative USB lines 28 and 30, respectively, allowing the Interface to communicate with any set top box featuring a USB data port. This includes any DirecTV® STB models D11, D12, R15, R16, H20, H21, HR20, HR21, and HR21P. Serial interaction with the USB and RJ45 jack is programmable allowing the Interface to be programmed for other interfaces and connections.

The status of the interface is signaled to the user or an installer by way of three light emitting diodes (LED's) 40, 42 and 44 mounted externally to the circuit board housing. The LED's 40, 42 and 44 are respectively coupled between a pull up resistor and each of three parallel interface lines of the microcontroller 20. LED 40 (POWER) is illuminated by the microcontroller when the circuit board is receiving power and the microcontroller is operating, LED 42 (STB LINK) is illuminated when the controller 20 senses a connection to a set top box via the USB connector 14 by way of serial traffic on that connection, and LED 44 (TV LINK) is illuminated when controller 20 senses a connection to a television via lines 24 and 26 by way of serial traffic on that connection.

It will be further appreciated that in the event a television receiver uses an USB connection a section USB-to-RS-232 IC could be used to couple the microcontroller to the television, or generally, other interface electronics may be used between the microcontroller and the television and set-top box for compatibility with communications media used by each.

The firmware in the microcontroller performs the following tasks:

1. In normal operation the TVs are instructed not to act on remote, front panel, and pillow speaker key presses that relate to functions of the associated set-top box, such as channel change, channel guide, and the like, but instead pass them through the CCI port. The microcontroller continuously monitors the CCI port for key presses by the user forwarded by the TVs. When a key is pressed, the microcontroller translates the code to the appropriate set top box code, e.g., a DirecTV® code, and forwards it to the associated STB.

2. When the user changes the TV input signal source away from the STB input (e.g. from Composite to HDMI, or vice-versa) the Interface automatically returns control of all keys to the TV and turns off the associated STB. This saves energy and allows the user full control over the TV when viewing, for example, digital broadcast channels, or channels available through a separate set top box.

In one embodiment, the interface of the television includes two-way communication, so that when the SETUP key on the television or remote is pressed, the Interface enters a configuration mode and commands the television to display a setup menu on the TV screen, displaying setup information for the Interface. In this setup mode the user may change each key's translation thereby allowing any TV, remote, or pillow speaker key to be translated to any function the associated STB supports.

It will be appreciated that the interface functions described above may be integrated into a television receiver or integrated into a set-top box, or used in a separately-housed circuit board (as described above) as appropriate for a particular environment.

When introducing elements of the present invention or various embodiments thereof, the articles “a”, “an”, “the”, and “said” are intended to mean that there are one or more of the elements. The terms “comprising”, “including”, and “having” are intended to be inclusive and mean that there may be additional elements other than the listed elements. Moreover, the use of “top” and “bottom”, “front” and “rear”, “above” and “below” and variations of these and other terms of orientation is made for convenience, but does not require any particular orientation of the components.

Therefore, the invention, in its broadest aspects, is not limited to the specific details shown and described herein. Consequently, departures may be made from the details described herein without departing from the spirit and scope of the claims, which follow

What is claimed is:

1. A set top box interface for one or more televisions operatively connected to one or more associated set top boxes, the interface comprising
a. a TV control interface to the one or more televisions for receiving control signals from the one or more televisions that are directed to the one or more associated set top boxes,
b. a STB control interface to the one or more associated set top boxes that delivers control signals to the one or more associated set top boxes, and
c. a controller programmed to receive control signals from the one or more televisions via the TV control interface, convert control signals from the one or more televisions to control signals for the one or more associated set top boxes, and deliver the control signals to the STB control interface.

2. The set top box interface of claim 1 wherein the TV control interface further delivers control signals to the one or more televisions for on-screen display, and the controller is programmed to provide content for on-screen displays to the one or more televisions.

3. The set top box interface of claim 2 wherein the controller provides on-screen displays to the TV control interface to present a current configuration for converting control signals from the one or more televisions to control signals for the STB control interface.

4. The set top box interface of claim 3 wherein the controller receives control signals from the TV control interface to change a current configuration for converting control signals from the television to control signals for the STB control interface.

5. The set top box interface of claim 1 wherein the controller delivers control signals to the TV control interface to instruct the television to ignore remote control-originated signals received by the one or more televisions while the one or more televisions are displaying a particular source, and provide those remote control-originated signals to the TV control interface, whereby the controller may perform conversion and delivery of those remote control-originated signals to the STB control interface to thus control an associated connected set top box.

6. The set top box interface of claim 1 wherein the controller passes an alternative signal to the associated television when the associated set top box is powered off.

7. The set top box interface of claim 1 wherein the controller delivers control signals to the TV control interface to instruct the associated television to process remote control-originated signals received by the associated television while the associated set top box is powered off.

8. The set top box interface of claim 1 wherein the controller delivers control signals to the TV control interface to instruct the associated television to display a specified channel when the associated set top box powers on.
